(19) United States
(12) Patent Application Publication
(10) Pub. No.: US 2015/0262424 A1
(43) Pub. Date: Sep. 17, 2015

(54) Depth and Focus Discrimination for a Head-mountable device using a Light-Field Display System

(71) Applicant: Google Inc., Mountain View, CA (US)

(72) Inventors: Corey TABAKA, Los Gatos, CA (US); Jasmine STRONG, San Francisco, CA (US)

(73) Assignee: Google Inc., Mountain View, CA (US)

(21) Appl. No.: 13/755,392

(22) Filed: Jan. 31, 2013

(51) Int. Cl. G06T 19/00

(52) U.S. Cl. CPC G06T 19/006

(57) ABSTRACT

A head-mountable device (HMD) is provided for augmenting a contemporaneously viewed “real image” of an object in a real-world environment using a light-field display system that allows for depth and focus discrimination. The HMD may include a light-producing display engine, a viewing location element, and a microlens array. The microlens array may be coupled to the light-producing display engine in a manner such that light emitted from the light-producing display engine is configured to follow an optical path through the microlens array to the viewing location element. The HMD may also include a processor configured to identify a feature of interest in a field-of-view associated with the HMD in an environment, obtain lightfield data, and render, based on the lightfield data, a lightfield that includes a synthetic image related to the feature of interest using depth and focus discrimination.

### BACKGROUND

Unless otherwise indicated herein, the materials described in this section are not prior art to the claims in this application and are not admitted to be prior art by inclusion in this section.

Computing devices such as personal computers, laptop computers, tablet computers, cellular phones, and countless types of Internet-capable devices are increasingly prevalent in numerous aspects of modern life. Over time, the manner in which these devices are providing information to users is becoming more intelligent, more efficient, more intuitive, and/or less obtrusive.

The trend toward miniaturization of computing hardware, peripherals, as well as of sensors, detectors, and image and audio processors, among other technologies, has helped open up a field sometimes referred to as “wearable computing.” In the area of image and visual processing and production, in particular, it has become possible to consider wearable displays that place a graphic display close enough to eye(s) of a wearer (or user) such that the displayed image appears as a normal-sized image, such as might be displayed on a traditional image display device. The relevant technology may be referred to as “near-eye displays.”

Wearable computing devices with near-eye displays may also be referred to as “head-mountable devices” (HMDs), “head-mounted displays,” “head-mounted devices,” or “head-mountable devices.” A head-mountable device places a graphic display or displays close to one or both eyes of a wearer. To generate the images on a display, a computer processing system may be used. Such displays may occupy an entire field of view of the wearer, or only occupy part of a field of view of the wearer. Further, head-mounted displays may vary in size, taking a smaller form such as a glasses-style display or a larger form such as a helmet, for example.

Emerging and anticipated uses of wearable displays include applications in which users interact in real time with an augmented or virtual reality. Such applications can be mission-critical or safety-critical, such as in a public safety or aviation setting. The applications can also be recreational, such as interactive gaming. Many other applications are also possible.

### SUMMARY

Within examples, a wearable display system, such as a head-mountable device, is provided for augmenting a contemporaneously viewed “real image” of an object in a real-world environment using a light-field display system that allows for depth and focus discrimination.

In a first embodiment, a head-mountable device (HMD) is provided. The HMD includes a light-producing display engine, a viewing location element, and a microlens array. The microlens array is coupled to the light-producing display engine in a manner such that light emitted from the light-producing display engine is configured to follow an optical path through the microlens array to the viewing location element. The HMD also includes a processor. The processor is configured to identify a feature of interest in a field-of-view associated with the HMD in an environment. The feature of interest may be associated with a depth to the HMD in the environment, and the feature of interest may be visible at the viewing location element. The processor is also configured to obtain lightfield data. The lightfield data is indicative of the environment and the feature of interest. The processor is additionally configured to render, based on the lightfield data, a lightfield comprising a synthetic image that is related to the feature of interest at a focal point that corresponds to the depth for display at the viewing location element.

In a second embodiment, a method is disclosed. The method includes identifying, using at least one processor of a head-mountable device (HMD), a feature of interest in a field-of-view associated with the HMD in an environment. The HMD comprises a light-producing display engine, a viewing location element, and a microlens array coupled to the light-producing display engine in a manner such that light emitted from the light-producing display engine is configured to follow an optical path through the microlens array to the viewing location element, and the feature of interest is associated with a depth to the HMD in the environment and visible at the viewing location element. The method also includes obtaining lightfield data. The lightfield data is indicative of the environment and the feature of interest. The method additionally includes rendering, based on the lightfield data, a lightfield comprising a synthetic image that is related to the feature of interest at a focal point that corresponds to the depth for display at the viewing location element.

These as well as other aspects, advantages, and alternatives, will become apparent to those of ordinary skill in the art by reading the following detailed description, with reference where appropriate to the accompanying figures.

### BRIEF DESCRIPTION OF THE DRAWINGS

FIG. 1A illustrates a wearable computing system, according to an example embodiment.

FIG. 1B illustrates an alternate view of the wearable computing system illustrated in FIG. 1A.

FIG. 1C illustrates another wearable computing system, according to an example embodiment.

FIG. 1D illustrates another wearable computing system, according to an example embodiment.

FIGS. 1E, 1F and 1G are simplified illustrations of the wearable computing system shown in FIG. 1D, being worn by a wearer.

FIG. 2 is a simplified block diagram of a computing device, according to an example embodiment.

FIG. 3A is a diagram of an implementation of light-field display system that may be used by the wearable computing systems illustrated in FIGS. 1A-1D, according to an example embodiment.

FIG. 3B is an example of an arrangement of a light-field display system that may be used by a wearer of one of the wearable computing systems depicted in FIGS. 1A-1D, according to an example embodiment.

FIG. 4 is a block diagram of an example processor that may be used by the light-field display system of FIG. 3A, according to an example embodiment.

FIGS. 5A-5B are block diagrams of example methods that may be carried out by a wearable computing system, using the light-field display system of FIG. 3A, according to an example embodiment.

FIG. 6 is a functional block diagram of a computing device that may be used in conjunction with the systems and methods described herein, according to an example embodiment.

FIG. 7 is a schematic illustrating a conceptual partial view of an example computer program product that includes a computer program for executing a computer process on a computing device according to an example embodiment.

### DETAILED DESCRIPTION

Example methods and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. In the following detailed description, reference is made to the accompanying figures, which form a part thereof. In the figures, similar symbols typically identify similar components, unless context dictates otherwise. Other embodiments may be utilized, and other changes may be made, without departing from the spirit or scope of the subject matter presented herein.

The example embodiments described herein are not meant to be limiting. It will be readily understood that the aspects of the present disclosure, as generally described herein, and illustrated in the figures, can be arranged, substituted, combined, separated, and designed in a wide variety of different configurations, all of which are explicitly contemplated herein.

A. Overview

To provide an augmented-reality experience, augmented-reality applications superimpose augmented information in the form of synthetic images at various locations that correspond with natural components of a real scene. Generally, the synthetic imagery is composed on a flat plane (usually the plane of a display of a device running the augmented-reality application), which overlays a view of the real scene. However, because the focal plane is fixed, the synthetic imagery may be displayed at one apparent distance and focal length from the user. Accordingly, in many augmented-reality applications there can be a clear separation between the synthetic components of the scene and the natural components (i.e., the synthetic imagery appears at one focal point, while the corresponding object from the real world appears at a different focal point), which may cause, for example, discontinuity of focus, difficulty recognizing corresponding synthetic and natural components, and/or lack of visual integration between the real and synthetic scene.

In some examples, HMDs capable of running augmented reality applications may be configured to project the synthetic images at a set focal length, which may not be desirable. For example, the highlight indicator (synthetic imagery) may be at one focal distance from the user, while the object to be highlighted is at another focal distance. Similarly, it may be difficult to highlight multiple objects within the scene of the HMD because each highlight indicator is at the same focal distance. In other examples, when a user is viewing an object of the real world through the synthetic image, the synthetic image may appear out of focus and blurry. This may lead to eyestrain of the user, and the inconsistency with the natural components may harm the verisimilitude of the augmented-reality experience, making it easy for the user to tell the difference between reality and virtual reality.

Similarly, users of HMDs who have asymmetric or astigmatic vision may also find it difficult to use HMDs in an augmented reality manner because the synthetic imagery and natural objects may seem out of focus or blurry due to the asymmetric or astigmatic vision, regardless of the problems mentioned above.

Within examples herein, an HMD may be configured to run an augmented reality application and sense an environment with various natural components. The HMD may be configured to render light-fields and/or stereoscopic imaging of the environment in a manner that may allow any augmented information in the form of synthetic images to appear at various depths or focal distances that correspond with the depth of the natural components in the environment, and may compensate for any visual defects including those resulting from an astigmatism.

To this end, disclosed is a HMD that includes a light-field display system. The light-field display system may be configured in a manner that ensures light emitted from a display engine follows an optical path through a microlens array before being viewed by a wearer of the HMD. This configuration allows lightfield data (a light filed is a function describing the amount of light moving in every direction through every point in space) to be produced that represents an environment of the wearer of the HMD. Using depth information obtained from the light-field technology, the HMD may render, into the eye of the wearer, a light field that includes information about the environment of the HMD in an augmented reality manner at distances and focal points that correspond to the actual distances and focal points of objects in the environment, and may simultaneously compensate for any visual defects.

To illustrate, in one example, consider an HMD in an office. The HMD may focus on feature points (natural components) in the environment. Such feature points may include a computer and a scanner, for example. The HMD may use light-field technology to acquire images of the office as well as information indicating where the scanner and computer are in the office, for example. Using the depth information obtained from the lightfield data, the HMD may place information about the scanner and/or computer on the HMD in an augmented reality manner at distances and focal points that correspond to the actual distances and focal points of the scanner and computer.

B. Example Wearable Computing Devices

Systems and devices in which example embodiments may be implemented will now be described in greater detail. In general, an example system may be implemented in or may take the form of a wearable computer (also referred to as a wearable computing device). In an example embodiment, a wearable computer takes the form of or includes a head-mountable device (HMD).

An example system may also be implemented in or take the form of other devices, such as a mobile phone, among other possibilities. Further, an example system may take the form of non-transitory computer readable medium, which has program instructions stored thereon that are executable by at a processor to provide the functionality described herein. An example system may also take the form of a device such as a wearable computer or mobile phone, or a subsystem of such a device, which includes such a non-transitory computer readable medium having such program instructions stored thereon.

An HMD may generally be any display device that is capable of being worn on the head and places a display in front of one or both eyes of the wearer. An HMD may take various forms such as a helmet or eyeglasses. As such, references to “eyeglasses” or a “glasses-style” HMD should be understood to refer to an HMD that has a glasses-like frame so that it can be worn on the head. Further, example embodiments may be implemented by or in association with an HMD with a single display or with two displays, which may be referred to as a “monocular” HMD or a “binocular” HMD, respectively.

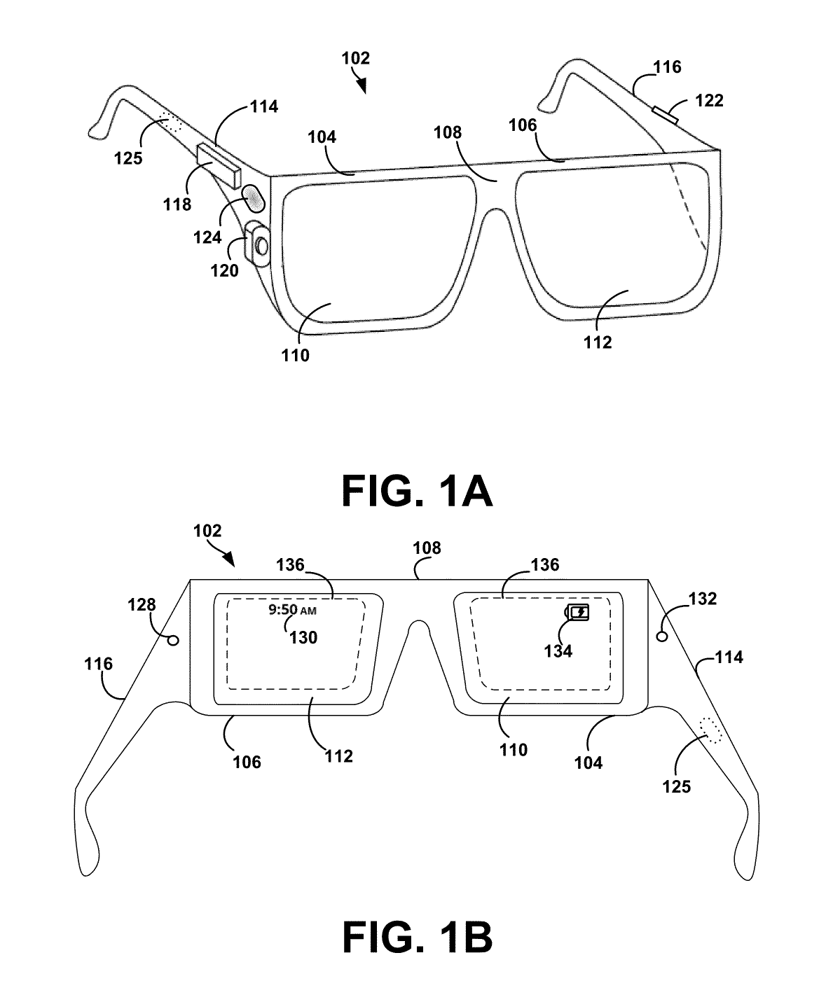

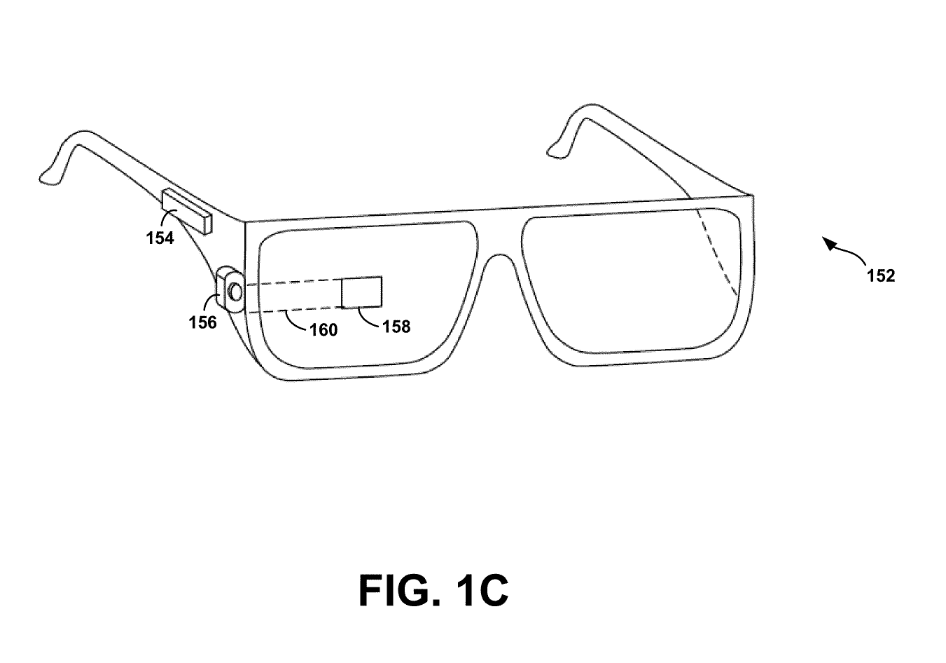

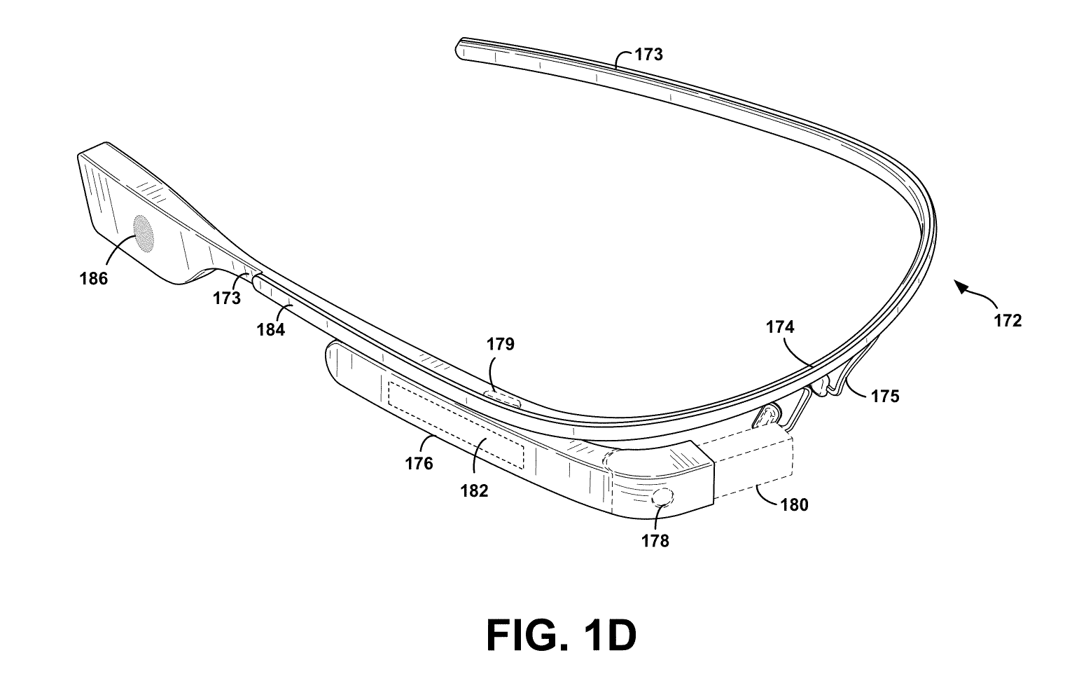

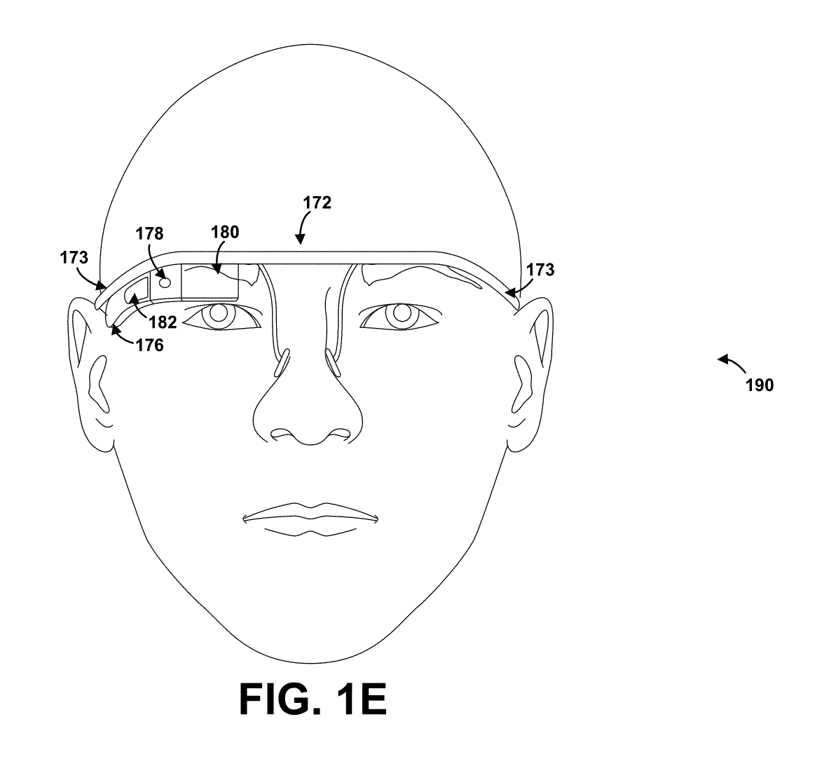

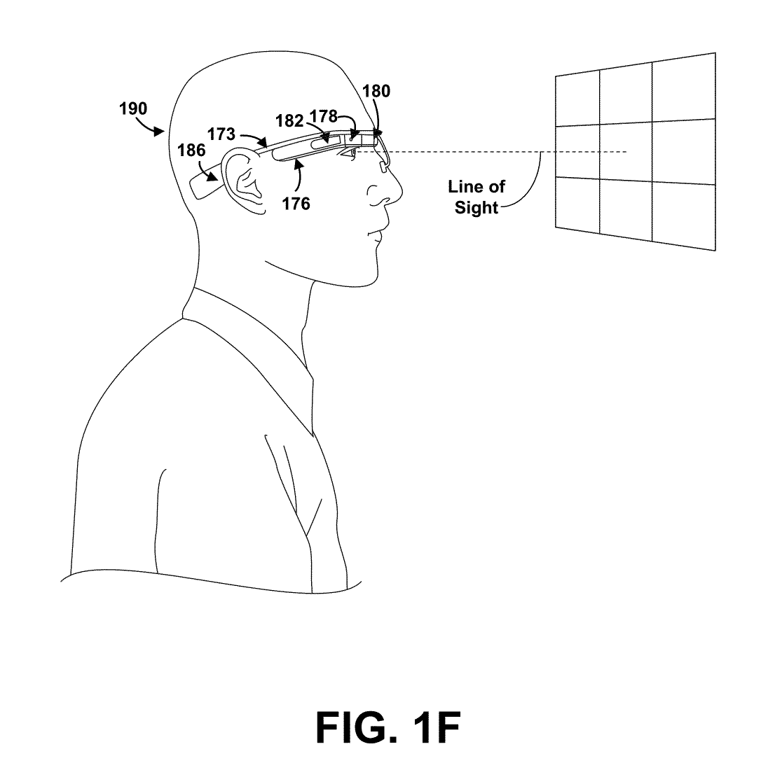

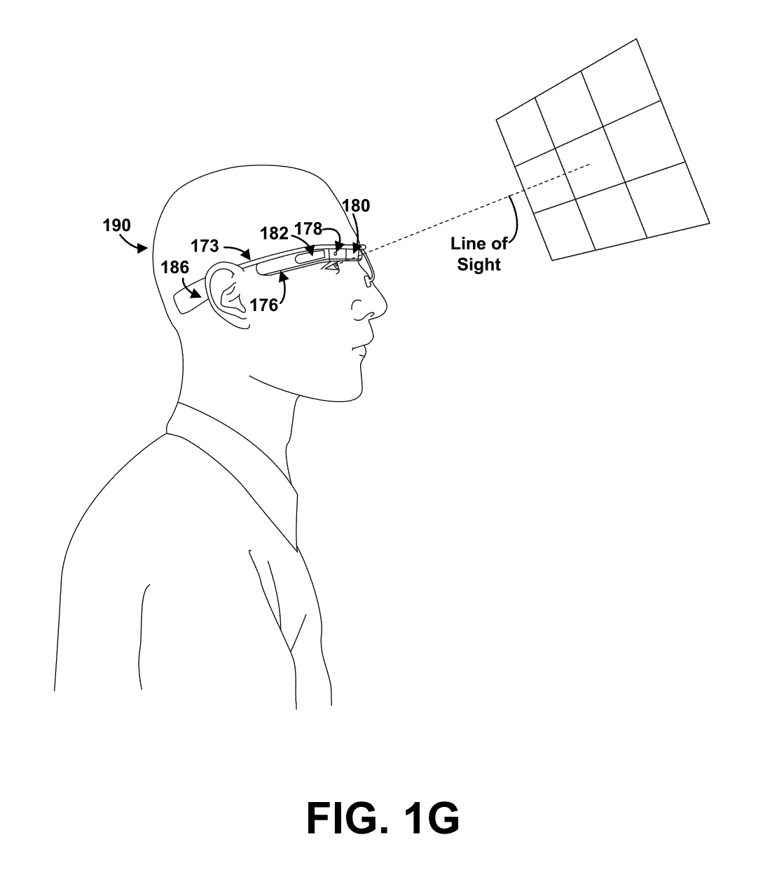

FIG. 1A illustrates a wearable computing system according to an example embodiment. In FIG. 1A, the wearable computing system takes the form of a head-mountable device (HMD) 102 (which may also be referred to as a head-mounted display). It should be understood, however, that example systems and devices may take the form of or be implemented within or in association with other types of devices, without departing from the scope of the invention. As illustrated in FIG. 1A, the HMD 102 includes frame elements including lens-frames 104, 106 and a center frame support 108, lens elements 110, 112, a light-field display system 136, and extending side-arms 114, 116. The center frame support 108 and the extending side-arms 114, 116 are configured to secure the HMD 102 to a face of a user via a nose and ears of the user, respectively.

Each of the frame elements 104, 106, and 108 and the extending side-arms 114, 116 may be formed of a solid structure of plastic and/or metal, or may be formed of a hollow structure of similar material so as to allow wiring and component interconnects to be internally routed through the HMD 102. Other materials may be possible as well.

One or more of each of the lens elements 110, 112 may be formed of any material that can suitably display a projected image or graphic. Each of the lens elements 110, 112 may also be sufficiently transparent to allow a user to see through the lens element. Combining these two features of the lens elements may facilitate an augmented reality or heads-up display where the projected image or graphic is superimposed over a real-world view as perceived by the user through the lens elements.

The extending side-arms 114, 116 may each be projections that extend away from the lens-frames 104, 106, respectively, and may be positioned behind ears of a user to secure the HMD 102 to the user. The extending side-arms 114, 116 may further secure the HMD 102 to the user by extending around a rear portion of the head of the user. Additionally or alternatively, for example, the HMD 102 may connect to or be affixed within a head-mounted helmet structure. Other configurations for an HMD are also possible.

The HMD 102 may also include an on-board computing system 118, an image capture device 120, a sensor 122, and a finger-operable touch pad 124. The on-board computing system 118 is shown to be positioned on the extending side-arm 114 of the HMD 102; however, the on-board computing system 118 may be provided on other parts of the HMD 102 or may be positioned remote from the HMD 102 (e.g., the on-board computing system 118 could be wire- or wirelessly-connected to the HMD 102). The on-board computing system 118 may include a processor and memory, for example. The on-board computing system 118 may be configured to receive and analyze data from the image capture device 120 and the finger-operable touch pad 124 (and possibly from other sensory devices, user interfaces, or both) and generate images for output by the lens elements 110 and 112.

The image capture device 120 may be, for example, a camera that is configured to capture still images and/or to capture video. In the illustrated configuration, image capture device 120 is positioned on the extending side-arm 114 of the HMD 102; however, the image capture device 120 may be provided on other parts of the HMD 102. The image capture device 120 may be configured to capture images at various resolutions or at different frame rates. Many image capture devices with a small form-factor, such as the cameras used in mobile phones or webcams, for example, may be incorporated into an example of the HMD 102.

Further, although FIG. 1A illustrates one image capture device 120, more image capture device may be used, and each may be configured to capture the same view, or to capture different views. For example, the image capture device 120 may be forward facing to capture at least a portion of the real-world view perceived by the user. This forward facing image captured by the image capture device 120 may then be used to generate an augmented reality where computer generated images appear to interact with or overlay the real-world view perceived by the user.

The sensor 122 is shown on the extending side-arm 116 of the HMD 102; however, the sensor 122 may be positioned on other parts of the HMD 102. For illustrative purposes, only one sensor 122 is shown. However, in an example embodiment, the HMD 102 may include multiple sensors. For example, an HMD 102 may include sensors 102 such as one or more gyroscopes, one or more accelerometers, one or more magnetometers, one or more light sensors, one or more infrared sensors, and/or one or more microphones. Other sensing devices may be included in addition or in the alternative to the sensors that are specifically identified herein.

The finger-operable touch pad 124 is shown on the extending side-arm 114 of the HMD 102. However, the finger-operable touch pad 124 may be positioned on other parts of the HMD 102. Also, more than one finger-operable touch pad may be present on the HMD 102. The finger-operable touch pad 124 may be used by a user to input commands. The finger-operable touch pad 124 may sense at least one of a pressure, position and/or a movement of one or more fingers via capacitive sensing, resistance sensing, or a surface acoustic wave process, among other possibilities. The finger-operable touch pad 124 may be capable of sensing movement of one or more fingers simultaneously, in addition to sensing movement in a direction parallel or planar to the pad surface, in a direction normal to the pad surface, or both, and may also be capable of sensing a level of pressure applied to the touch pad surface. In some embodiments, the finger-operable touch pad 124 may be formed of one or more translucent or transparent insulating layers and one or more translucent or transparent conducting layers. Edges of the finger-operable touch pad 124 may be formed to have a raised, indented, or roughened surface, so as to provide tactile feedback to a user when a finger of the user reaches the edge, or other area, of the finger-operable touch pad 124. If more than one finger-operable touch pad is present, each finger-operable touch pad may be operated independently, and may provide a different function.

In a further aspect, HMD 102 may be configured to receive user input in various ways, in addition or in the alternative to user input received via finger-operable touch pad 124. For example, on-board computing system 118 may implement a speech-to-text process and utilize a syntax that maps certain spoken commands to certain actions. In addition, HMD 102 may include one or more microphones via which speech of a wearer may be captured. Configured as such, HMD 102 may be operable to detect spoken commands and carry out various computing functions that correspond to the spoken commands.

As another example, HMD 102 may interpret certain head-movements as user input. For example, when HMD 102 is worn, HMD 102 may use one or more gyroscopes and/or one or more accelerometers to detect head movement. The HMD 102 may then interpret certain head-movements as being user input, such as nodding, or looking up, down, left, or right. An HMD 102 could also pan or scroll through graphics in a display according to movement. Other types of actions may also be mapped to head movement.

As yet another example, HMD 102 may interpret certain gestures (e.g., by a hand or hands of the wearer) as user input. For example, HMD 102 may capture hand movements by analyzing image data from image capture device 120, and initiate actions that are defined as corresponding to certain hand movements.

As a further example, HMD 102 may interpret eye movement as user input. In particular, HMD 102 may include one or more inward-facing image capture devices and/or one or more other inward-facing sensors (not shown) that may be used to track eye movements and/or determine the direction of a gaze of a wearer. As such, certain eye movements may be mapped to certain actions. For example, certain actions may be defined as corresponding to movement of the eye in a certain direction, a blink, and/or a wink, among other possibilities.

HMD 102 also includes a speaker 125 for generating audio output. In one example, the speaker could be in the form of a bone conduction speaker, also referred to as a bone conduction transducer (BCT). Speaker 125 may be, for example, a vibration transducer or an electroacoustic transducer that produces sound in response to an electrical audio signal input. The frame of HMD 102 may be designed such that when a user wears HMD 102, the speaker 125 contacts the wearer. Alternatively, speaker 125 may be embedded within the frame of HMD 102 and positioned such that, when the HMD 102 is worn, speaker 125 vibrates a portion of the frame that contacts the wearer. In either case, HMD 102 may be configured to send an audio signal to speaker 125, so that vibration of the speaker may be directly or indirectly transferred to the bone structure of the wearer. When the vibrations travel through the bone structure to the bones in the middle ear of the wearer, the wearer can interpret the vibrations provided by BCT 125 as sounds.

Various types of bone-conduction transducers (BCTs) may be implemented, depending upon the particular implementation. Generally, any component that is arranged to vibrate the HMD 102 may be incorporated as a vibration transducer. Yet further it should be understood that an HMD 102 may include a single speaker 125 or multiple speakers. In addition, the location(s) of speaker(s) on the HMD may vary, depending upon the implementation. For example, a speaker may be located proximate to a temple of a wearer (as shown), behind the ear of a wearer, proximate to the nose of the wearer, and/or at any other location where the speaker 125 can vibrate the wearer's bone structure.

FIG. 1B illustrates an alternate view of the wearable computing device illustrated in FIG. 1A. As shown in FIG. 1B, the lens elements 110, 112 may act as display elements. The HMD 102 may include a first projector 128 coupled to an inside surface of the extending side-arm 116 and configured to project a display 130 onto an inside surface of the lens element 112. Additionally or alternatively, a second projector 132 may be coupled to an inside surface of the extending side-arm 114 and configured to project a display 134 onto an inside surface of the lens element 110.

The lens elements 110, 112 may act as a combiner in a light projection system and may include a coating that reflects the light projected onto them from the projectors 128, 132. In some embodiments, a reflective coating may not be used (e.g., when the projectors 128, 132 are scanning laser devices).

In alternative embodiments, other types of display elements may also be used. For example, the lens elements 110, 112 themselves may include: a transparent or semi-transparent matrix display, such as an electroluminescent display or a liquid crystal display, one or more waveguides for delivering an image to the eyes of a user, or other optical elements capable of delivering an in focus near-to-eye image to the user. A corresponding display driver may be disposed within the frame elements 104, 106 for driving such a matrix display. Alternatively or additionally, a laser or LED source and scanning system could be used to draw a raster display directly onto the retina of one or more of the eyes of the user. Other possibilities exist as well.

In further embodiments, the lens elements 110, 112 may include a light-field display system 136. The light-field display system 136 may be affixed to the lens elements 110, 112 in a manner that allows the light-field display system 136 to be undetectable to a wearer of the HMD (i.e., the view of the real world of the wearer is unobstructed by the light-field display system). The light-field display system 136 may include optical elements that are configured to generate a lightfield and/or lightfield data including a display engine, a microlens array, and a viewing location element. The display engine may incorporate any of the display elements discussed above (e.g., projectors 128, 132). In other embodiments, the display system may be separate and include other optical elements. The viewing location element may be lens elements 110, 112, for example. Other elements may be included in light-field display system 136, and light-field display system 136 may be arranged in other ways. For example, the light-field display system 136 may be affixed to lens frames 104, 106 and may have separation from lens elements 110, 112. As another example, light-field display system 136 may be affixed to center frame support 108.

FIG. 1C illustrates another wearable computing system according to an example embodiment, which takes the form of an HMD 152. The HMD 152 may include frame elements and side-arms such as those described with respect to FIGS. 1A and 1B. The HMD 152 may additionally include an on-board computing system 154 and an image capture device 156, such as those described with respect to FIGS. 1A and 1B. The image capture device 156 is shown mounted on a frame of the HMD 152. However, the image capture device 156 may be mounted at other positions as well.

As shown in FIG. 1C, the HMD 152 may include a single display 158 which may be coupled to the device. The display 158 may be formed on one of the lens elements of the HMD 152, such as a lens element described with respect to FIGS. 1A and 1B, and may be configured to overlay computer-generated graphics in the view of the physical world of the user. The display 158 is shown to be provided in a center of a lens of the HMD 152, however, the display 158 may be provided in other positions, such as for example towards either the upper or lower portions of the field of view of the wearer. The display 158 is controllable via the computing system 154 that is coupled to the display 158 via an optical waveguide 160. The display 158 may comprise or be coupled to a light-field display system, although a light-field display system is not shown in FIG. 1C.

FIG. 1D illustrates another wearable computing system according to an example embodiment, which takes the form of a monocular HMD 172. The HMD 172 may include side-arms 173, a center frame support 174, and a bridge portion with nosepiece 175. In the example shown in FIG. 1D, the center frame support 174 connects the side-arms 173. The HMD 172 does not include lens-frames containing lens elements. The HMD 172 may additionally include a component housing 176, which may include an on-board computing system (not shown), an image capture device 178, and a button 179 for operating the image capture device 178 (and/or usable for other purposes). Component housing 176 may also include other electrical components and/or may be electrically connected to electrical components at other locations within or on the HMD. HMD 172 also includes a BCT 186.

The HMD 172 may include a single display 180, which may be coupled to one of the side-arms 173 via the component housing 176. In an example embodiment, the display 180 may be a see-through display, which is made of glass and/or another transparent or translucent material, such that the wearer can see their environment through the display 180. The display 180 may include a light-field display system (not shown in FIG. 1D). Further, the component housing 176 may include the light sources (not shown) for the display 180 and/or optical elements (not shown) to direct light from the light sources to the display 180. As such, display 180 may include optical features that direct light that is generated by such light sources towards the eye of the wearer, when HMD 172 is being worn, such as, for example, optical features that comprise a light-field display system (not shown).

In a further aspect, HMD 172 may include a sliding feature 184, which may be used to adjust the length of the side-arms 173. Thus, sliding feature 184 may be used to adjust the fit of HMD 172. Further, an HMD may include other features that allow a wearer to adjust the fit of the HMD, without departing from the scope of the invention.

FIGS. 1E to 1G are simplified illustrations of the HMD 172 shown in FIG. 1D, being worn by a wearer 190. As shown in FIG. 1F, when HMD 172 is worn, BCT 186 is arranged such that when HMD 172 is worn, BCT 186 is located behind the ear of the wearer. As such, BCT 186 is not visible from the perspective shown in FIG. 1E.

In the illustrated example, the display 180 may be arranged such that when HMD 172 is worn, display 180 is positioned in front of or proximate to an eye of a user when the HMD 172 is worn by a user. For example, display 180 may be positioned below the center frame support and above the center of the eye of the wearer, as shown in FIG. 1E. Further, in the illustrated configuration, display 180 may be offset from the center of the eye of the wearer (e.g., so that the center of display 180 is positioned to the right and above of the center of the wearer's eye, from the perspective of the wearer).

Configured as shown in FIGS. 1E to 1G, display 180 may be located in the periphery of the field of view of the wearer 190, when HMD 172 is worn. Thus, as shown by FIG. 1F, when the wearer 190 looks forward, the wearer 190 may see the display 180 with their peripheral vision. As a result, display 180 may be outside the central portion of the field of view of the wearer when their eye is facing forward, as it commonly is for many day-to-day activities. Such positioning can facilitate unobstructed eye-to-eye conversations with others, as well as generally providing unobstructed viewing and perception of the world within the central portion of the field of view of the wearer. Further, when the display 180 is located as shown, the wearer 190 may view the display 180 by, e.g., looking up with their eyes only (possibly without moving their head). This is illustrated as shown in FIG. 1G, where the wearer has moved their eyes to look up and align their line of sight with display 180. A wearer might also use the display by tilting their head down and aligning their eye with the display 180.

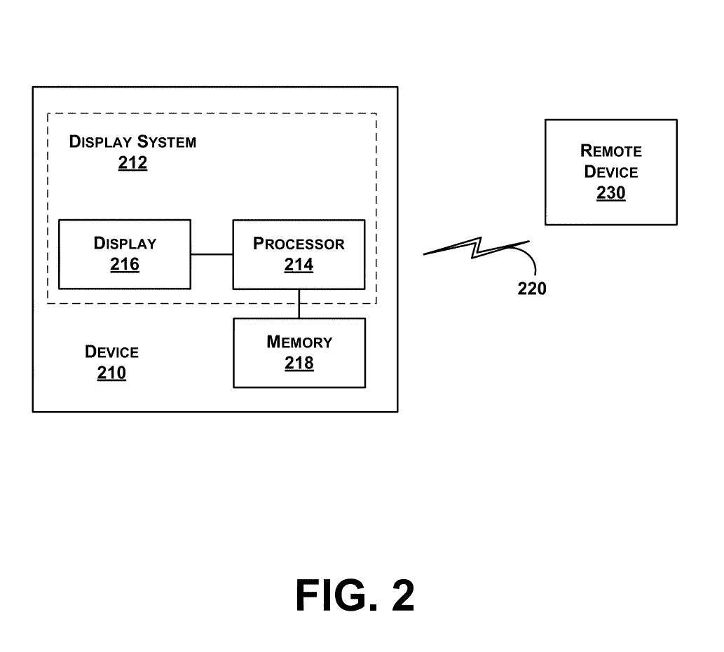

FIG. 2 is a simplified block diagram of a computing device 210 according to an example embodiment. In an example embodiment, device 210 communicates using a communication link 220 (e.g., a wired or wireless connection) to a remote device 230. The device 210 may be any type of device that can receive data and display information corresponding to or associated with the data. For example, the device 210 may be a heads-up display system, such as the head-mounted devices 102, 152, or 172 described with reference to FIGS. 1A to 1G.

Thus, the device 210 may include a display system 212 comprising a processor 214 and a display 216. The display 216 may be, for example, an optical see-through display, an optical see-around display, or a video see-through display, and may comprise components of a light-field display system. The processor 214 may receive data from the remote device 230, and configure the data for display on the display 216. The processor 214 may be any type of processor, such as a micro-processor or a digital signal processor, for example.

The device 210 may further include on-board data storage, such as memory 218 coupled to the processor 214. The memory 218 may store software that can be accessed and executed by the processor 214, for example.

The remote device 230 may be any type of computing device or transmitter including a laptop computer, a mobile telephone, or tablet computing device, etc., that is configured to transmit data to the device 210. The remote device 230 and the device 210 may contain hardware to enable the communication link 220, such as processors, transmitters, receivers, antennas, etc.

Further, remote device 230 may take the form of or be implemented in a computing system that is in communication with and configured to perform functions on behalf of client device, such as computing device 210. Such a remote device 230 may receive data from another computing device 210 (e.g., an HMD 102, 152, or 172 or a mobile phone), perform certain processing functions on behalf of the device 210, and then send the resulting data back to device 210. This functionality may be referred to as “cloud” computing.

In FIG. 2, the communication link 220 is illustrated as a wireless connection; however, wired connections may also be used. For example, the communication link 220 may be a wired serial bus such as a universal serial bus or a parallel bus. A wired connection may be a proprietary connection as well. The communication link 220 may also be a wireless connection using, e.g., Bluetooth® radio technology, communication protocols described in IEEE 802.11 (including any IEEE 802.11 revisions), Cellular technology (such as GSM, CDMA, UMTS, EV-DO, WiMAX, or LTE), or Zigbee® technology, among other possibilities. The remote device 230 may be accessible via the Internet and may include a computing cluster associated with a particular web service (e.g., social-networking, photo sharing, address book, etc.).

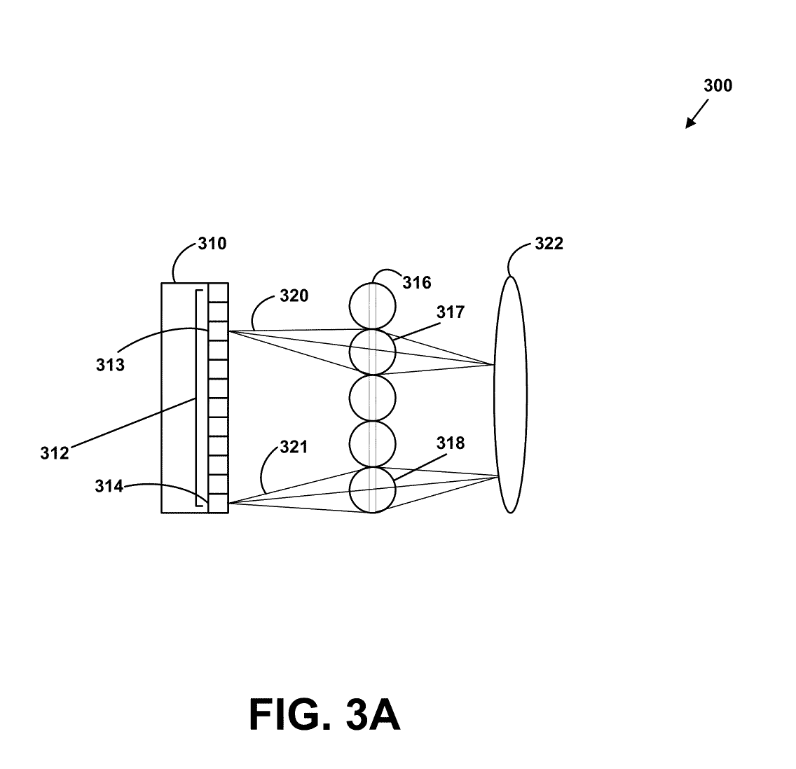

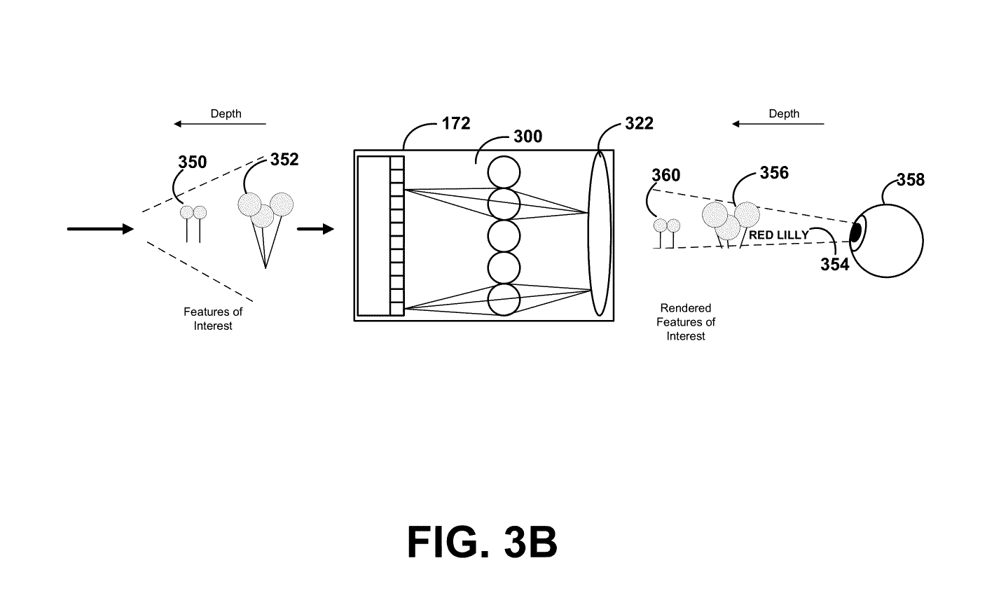

FIG. 3A illustrates a side view of an implementation of a light-field display system 300. The light-field display system 300 may include a display engine 310, a microlens array 316, and a viewing location element 322. The light-field display system 300 may be coupled to an HMD, such as one of the HMDs discussed above in section (B), or in some examples may be considered a component of an HMD.

In one example, the display engine 310 may include an organic light emitting diode (OLED). The OLED may be a transparent or semi-transparent matrix display that allows the wearer of the HMD to view the synthetic image produced by the OLED as well as allowing the wearer of the HMD to view light and objects from the real world. In other examples, the display engine 310 may include other light producing displays such as a liquid crystal display (LCD), a Liquid Crystal over Silicon (LCoS) display, or microelectro-mechanical systems (MEMS) projector device such as a Digital Light Processing (DLP) or PicoP projector. In further examples, the display may incorporate or be any of the display elements discussed above with regard to FIGS. 1A-1G.

Note that while the display engine 310 is shown at a separation distance from microlens array 316 and viewing location element 322, this is not intended to be limiting. In other arrangements display engine 310 may be contiguous to microlens array 316, which may be contiguous to the viewing location element 322. Other arrangements are possible as well, and the display engine 310, microlens array 316, and viewing location element 322 may be arranged in any suitable manner so long as the light-field display system 300 is able to accomplish the disclosed functionality.

The display engine 310 may further include a plurality of pixels 312 that generate light (e.g., light rays 320 and 321, which are discussed in more detail later). Each pixel in the plurality of pixels 312 represents a unit of the display engine, and each pixel may be activated to generate light independently. For example, pixel 313 may be activated to generate light with a particular color and intensity that is different than that of pixel 314. In other examples, pixels 313, 314 may be activated to generate light with the same color and intensity.

Although the pixels 313, 314 take the shape of a square in FIG. 3A, in other examples, each pixel in the plurality of pixels 312 may take any shape including round, oval, rectangular or square. Moreover, although FIG. 3A depicts a finite number of pixels (which make up the plurality of pixels) any number of pixels may be stored in the display engine, and while FIG. 3A depicts the pixels from a side view, there may be additional columns of pixels that are not visible. For example, the display engine 310 may include an OLED display which may have a pixel resolution of 800×600 pixels. Other resolutions may be used, and may be determined based on the type of display.

The light-field display system 300 may further include a microlens array 316. The microlens array 316 may include a plurality of microlenses such as microlenses 317, 318. While the microlens array 316 in FIG. 3A is depicted as having five microlenses (including microlenses 317, 318) in other examples, any number of microlenses may be used in the microlens array. In some examples, the microlens array may be configured as a one-dimensional (1D) microlens array, while in other examples the microlens array may be configured as a two-dimensional (2D) microlens array. Moreover, because FIG. 3A is a side view of the display engine 310, microlens array 316 may include additional microlenses that are not visible. For example, microlens array 316 may include additional columns of microlenses that are not visible.

Each microlens depicted in FIG. 3A takes the shape of a circle. However, in other examples, each microlens may take the form of another shape. Moreover, in FIG. 3A the microlens array 316 is arranged in a square pattern (i.e., columns and rows). However, in other embodiments the microlenses may be arranged in a variety of patterns including a hexagonal, octagonal, or other shaped grid.

The microlens array 316 may be positioned behind the light-emitting display engine 310 and in front of viewing element 322 (e.g., between the light-emitting display engine 310 and the viewing element 322). In some examples, the microlens array 316 may be configured such that one or more microlenses of the microlens array correspond to the plurality of pixels and are disposed in front of the plurality of pixels and at a separation from the plurality of pixels. The distance between the display engine 310 and microlens array 316 may be sufficient to allow light passing from each pixel to pass through each microlens of the microlens array 316. For example, as illustrated in in FIG. 3A, light 320 from a first pixel 313 passes through microlens 317 and is visible at the viewing location element 322, and light 321 from a second pixel 314 passes through microlens 318 and is also visible at the viewing location element 322. While light 320, 321 are shown passing through microlens 317, 318 respectively, light 320, 321 may also pass through the other microlenses of the microlens array 316 (not shown).

The viewing location element 322 may be the lens elements 110, 112 discussed above with reference to FIGS. 1A-1D, for example. In other arrangements, the viewing location element 322 may be a separate lens element, other than lens elements 110, 112, but may take the any form discussed with respect to lens elements 110, 112.

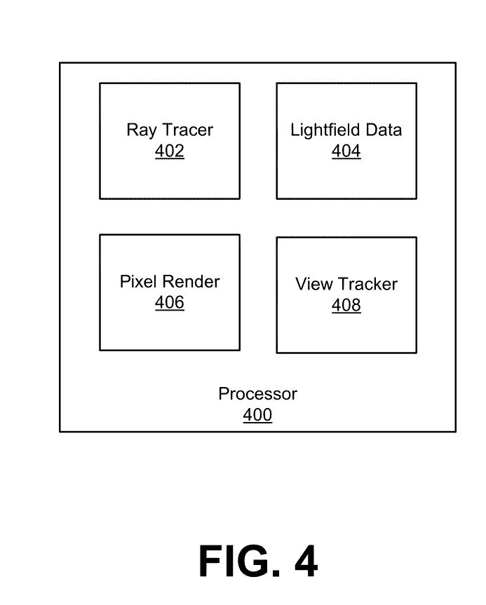

A display engine processor (not shown) may control the plurality of pixels 312 to generate light such as light 320, 321. The display engine processor may be the same or similar to processor 214. In other examples, the components of processor 400, described in FIG. 4, may be part of processor 214. In further examples, the display engine processor may be separate to that of processor 214. The display engine processor may, for example, control the color and intensity of the light displayed by each pixel. The display engine processor may also render particular lightfield data to be viewed at the viewing location element 322. The rendered light field may be a three-dimensional (3D) or four-dimensional (4D) image or scene, for example.

FIG. 3B illustrates an example of an arrangement of the light-field display system 300 that may be used with an HMD interacting with an eye 358, and will be discussed in more detail later in this disclosure. Briefly, in FIG. 3B, a user (represented by eye 358) is operating HMD 172, which includes light-field display system 300. As depicted, a user views “features of interest” wearing HMD 172 comprising a light-field display system 300. Light, demarcated by the bold arrows, penetrates the HMD in a manner such that lightfield data is captured that represents the environment the wearer of HMD 172 is viewing, or as depicted in FIG. 3B, features of interest 350, 352. The lightfield data may be captured, for example using a lightfield camera. In other examples, the lightfield data may be received from a remote entity, but may still represent the environment the wearer is viewing.

Note, light and depth data that defines the environment may be obtained in manners other than utilizing a light field camera. In other examples, the data defining the environment may, for example, be obtained by two cameras offset to measure depth via stereopsis or using a monocular configuration that measures depth via motion parallax.

Upon capturing the lightfield data, a processor of the HMD may produce the lightfield for the wearer. To do so, the lightfield data may be reproduced to accurately reflect what the wearer sees (e.g., based on the gaze of the wearer of the HMD), and may be used to render a lightfield representing the environment. In other examples the lightfield data may be processed to incorporate synthetic images or altered to compensate for astigmatisms or irregularities in the eye of the wearer of HMD 172 or lens of HMD 172. Once the lightfield data has been produced, an appropriate light-field may be rendered for viewing by the user.

When the data defining the environment is obtained utilizing methods other than a lightfield camera, the data may be used to generate lightfield data that may be used to render a lightfield representing the environment. Similar to the scenario in which lightfield data is captured using a lightfield camera, the generated lightfield data may also be processed to incorporate synthetic images or altered to compensate for astigmatism or irregularities in the eye of the wearer of HMD 172 or lens of HMD 172. In other examples, the generated lightfield data may be processed to compensate for irregularities or detrimental qualities of any part of the optical train of the HMD 172.

FIG. 4 is a block diagram illustrating an implementation of a processor 400 that may be used by the light-field display system 300. As shown, processor 400 may include a variety of components including a Ray Tracer 402, Lightfield Data 404, Pixel Renderer 406, and a View Tracker 408. The view tracker 408 may determine a certain view at the viewing location element 322 associated with the light-field display system 300. For example, the view tracker 408 may receive view/gaze information of the HMD from the sensors described above with regard to FIGS. 1A-1G. Other systems may be used to determine the view associated with the light-field display system.

The ray tracer 402 may determine which pixels of the plurality of pixels 312 of the display engine 310 are visible through each microlens of the microlens array 316 within the view associated with the HMD (as determined by, for example, the view tracker 408).

In some examples, the ray tracer 402 may determine which pixels are visible through each individual microlens of the microlens array 312 by performing ray tracing from various points on the determined location of the eye of the wearer of the HMD through each microlens of the microlens array 316, and determine which pixels of the plurality of pixels 312 are reached by the rays for each microlens. The pixels that can be reached by a ray originating from the eye (e.g., pupil) of the wearer of the HMD through a microlens of the microlens array 316 are the pixels that are visible by the eye of the wearer of the HMD at the viewing location element.

In other examples, the ray tracer 402 may determine which pixels are visible through each individual microlens of the microlens array 316 by performing ray tracing from each of the plurality of pixels through each microlens of the microlens array 316. To do so, for each pixel of the plurality of pixels 312 (including pixels 313 and 314), a ray may be traced to a certain point of the eye of a wearer. The intersection of the ray with the microlens array 312 may be determined. In some examples, the ray may be traced from various locations within the pixel, and if no ray intersects the eye, then the pixel is not visible to the user.

The pixel renderer 406 may control the output of the pixels 312 such that the appropriate light-field is displayed to a wearer of the HMD comprising the light-field display system 300. In other words, the pixel renderer 406 may utilize output from the ray tracer 402 and the lightfield data that is obtained by the wearer (e.g., by viewing a real-world environment through the HMD) to determine or predict the output of the pixels 312 that will result in the lightfield data being correctly rendered to a viewer of the light-field display system 300.

Example methods for utilizing a HMD comprising a light-field display system 300 are discussed below.

C. Example Methods

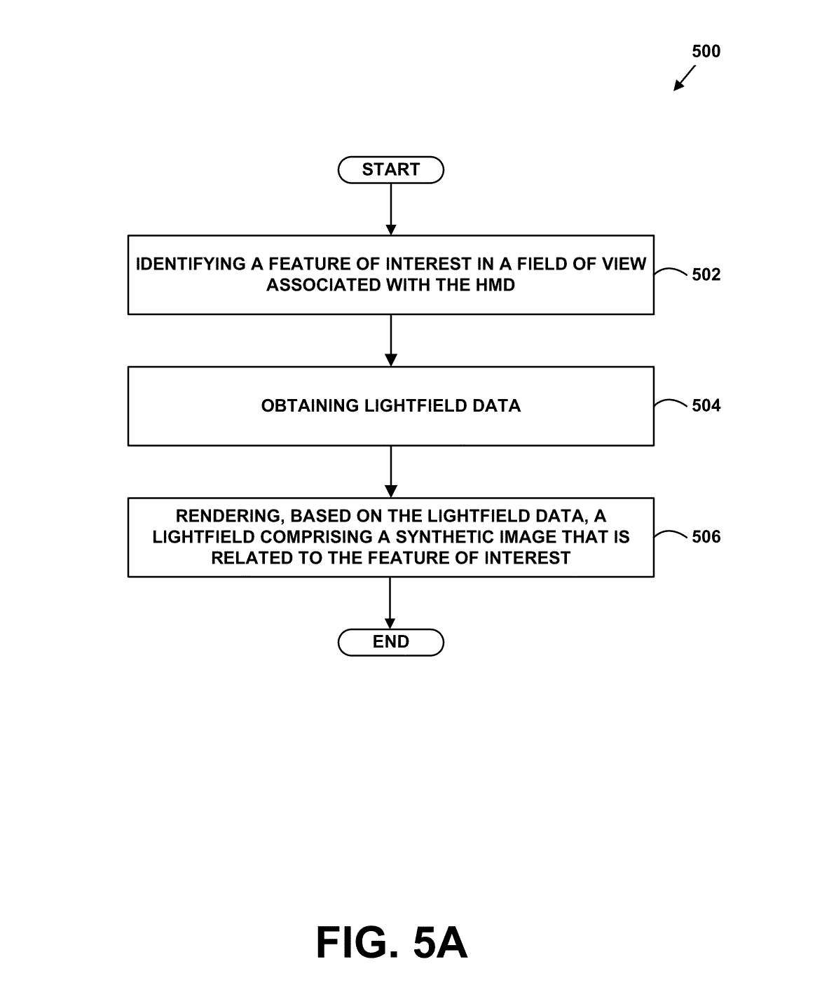

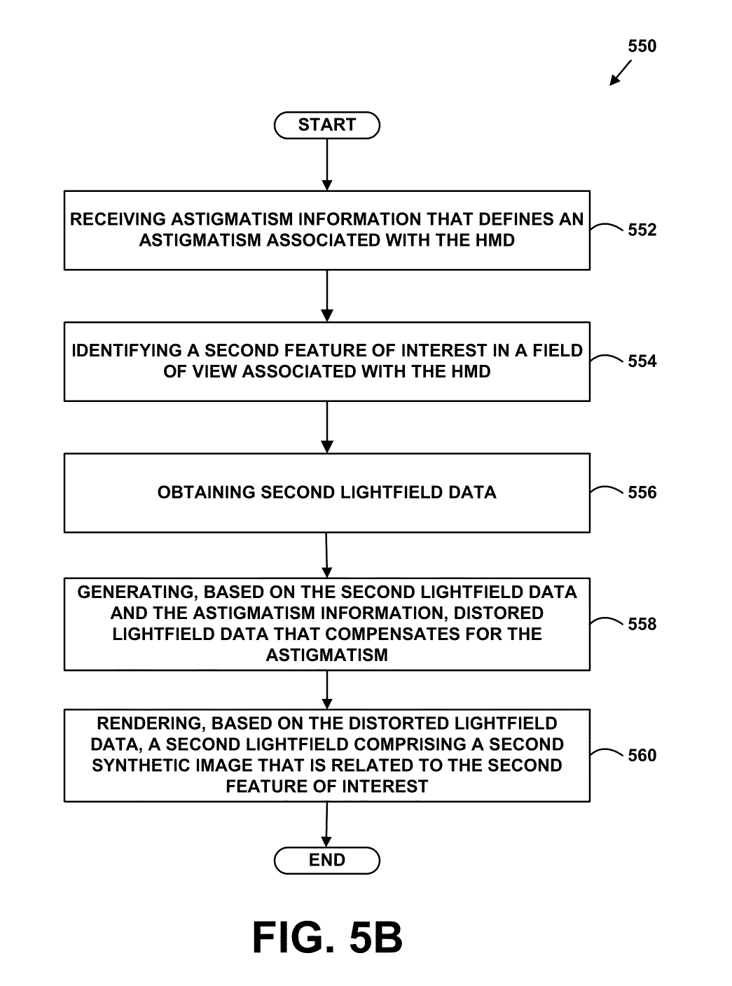

FIG. 5A is a block diagram of an example method for providing depth and focus discrimination using a HMD that includes a light-field display system, such as light-field display system 300. Method 500 shown in FIG. 5A presents an embodiment of a method that, for example, may be performed by a device the same as or similar to that discussed with regard to FIGS. 1-3. For example, method 500 may be implemented by a user wearing HMD 172 depicted in FIG. 1D, which comprises a light-field display system (although not shown in FIG. 1D), and will be referenced as such in discussing method 500. Method 500 may include one or more operations, functions, or actions as illustrated by one or more of blocks 502-506. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

In addition, for the method 500 and other processes and methods disclosed herein, the flowchart shows functionality and operation of one possible implementation of present embodiments. In this regard, each block may represent a module, a segment, or a portion of program code, which includes one or more instructions executable by a processor or computing device for implementing specific logical functions or steps in the process. The program code may be stored on any type of computer readable medium or memory, for example, such as a storage device including a disk or hard drive. The computer readable medium may include non-transitory computer readable media, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, or compact-disc read only memory (CD-ROM), for example. The computer readable media may also be any other volatile or non-volatile storage systems. The computer readable medium may be considered a computer readable storage medium, for example, or a tangible storage device.

Initially, at block 502, method 500 includes identifying a feature of interest in a field of view associated with HMD 172. The feature of interest may comprise an object in an environment of HMD 172. The feature of interest may be determined by the sensors of HMD 172 along with the view tracker 406, for example. The sensors may detect the angle and direction of the eye of the wearer and determine a view associated with the direction and angle. The HMD 172 may transmit the viewing information to the view tracker 406.

For example, a user of HMD 172 may be in a garden. While operating the HMD, the user may focus on flowers (e.g., by focusing his/her eyes on the flowers) located in the garden. The flowers may be associated with a location and a perceived depth to the user. There may be other flowers or objects in the garden that are visible by the wearer of the HMD, and in some instances the wearer may focus on many flowers. In such an instance, each of the flowers may be associated with varying depths and locations. Some flowers may have the same depth and location. After accurately positioning his/her eyes, the user may wink and cause, using the proximity sensor 136, the HMD 102 to acquire image data indicative of the flowers in the garden. The image data may be captured in any manner discussed above with regard to FIGS. 1A-1G. FIG. 3B illustrates such a scenario. In FIG. 3B the user of HMD 172 perceives features of interest 350, 352 using light-field display system 300. Feature of interest 350 is at one depth to the HMD, while feature of interest 352 is at another.

Once the feature of interest has been determined, at block 504, method 500 includes obtaining lightfield data. To do so, an image of the environment may be captured, for example by image capture device 178 that may gather light defining the environment. With respect to FIG. 3B, the lightfield data represents all of the light that passes through the flowers. In other examples, the light that defines the environment may be provided to the light-field display system in the form of lightfield data from a remote device.

Once the lightfield data has been obtained, at step 506, method 500 includes rendering, based on the lightfield data, a lightfield comprising a synthetic image that is related to the feature of interest. The rendered lightfield may be a lightfield described by the lightfield data and may include the synthetic image. The synthetic image may correspond to the location and perceived depth of the feature of interest. The rendering, may occur, for example using pixel renderer 406, which may use the output of ray tracer 402. In practice, the lightfield data that defines the environment may be rendered along with the synthetic image. In FIG. 3B, features of interest 350, 352 have been rendered as Rendered Features of Interest 356, 360 along with synthetic image 354 that indicates to the user that he/she is viewing a “RED LILLY.” As shown, the synthetic image is displayed at a depth associated with rendered feature of interest 356. Thus, while the wearer of HMD 172 can view both rendered feature of interest 356 and rendered feature of interest 360, he/she can easily determine which rendered featured of interest is associated with the synthetic imagery 354.

Note that while “RED LILLY” is used as the synthetic imagery, it is meant only to be an example, and other synthetic images are possible. Further, in FIG. 3B, the rendered feature of interest 356 is shown depicted outside of viewing location element 322 for ease of explanation, and is not meant to be limiting. In practice, the rendered feature of interest may be rendered at viewing location element 322 or directly in the eye 358 of the user.

Rendering the lightfield synthetic image may be performed in any known rendering manner. Many different and specialized rendering algorithms have been developed such as scan-line rendering or ray-tracing, for example. Ray tracing is a method to produce realistic images by determining visible surfaces in an image at the pixel level. The ray tracing algorithm generates an image by tracing the path of light through pixels in an image plane and simulating the effects of its encounters with virtual objects. Scan-line rendering generates images on a row-by-row basis rather than a pixel-by-pixel basis. All of the polygons representing the 3D object data model are sorted, and then the image is computed using the intersection of a scan line with the polygons as the scan line is advanced down the picture.

FIG. 5B is a block diagram of another example method 550 that utilizes an HMD capable of depth and focus discrimination using a light-field display system. In method 550, the HMD utilizes a light-field display system to address an astigmatism that may be associated with the HMD. As noted in reference to method 500, method 550 may be implemented by a user wearing HMD 172 depicted in FIG. 1D, which comprises a light-field display system 300, and will be referenced as such in discussing method 550.

Initially, at block, 552, method 550 includes receiving astigmatism information that defines an astigmatism associated with HMD 172. The astigmatism may be associated with an eye of the user of HMD 172 or with the viewing lens 180, for example. The astigmatism information may be received in the form of data and can be, but need not be, data that was input by the user of HMD 172. The data may, for example, comprise information that defines the astigmatism such as a prescription that may be associated with the astigmatism. The astigmatism information may comprise any data format capable of organizing and storing astigmatism information.

Once the astigmatism information has been received, at block 554, method 550 includes identifying, a second feature of interest in a field of view associated with HMD 172. The field of view and second feature of interest may be determined in the same or similar manner as that discussed above with regard to method 500, for example.

At block, 556, method 550 includes obtaining second lightfield data. The second lightfield data may be obtained in the same or similar fashion as that discussed above with regard to method 500, for example.

At block 558, the method 550 includes generating, based on the second lightfield data and the astigmatism information, distorted lightfield data that compensates for or cancels out the astigmatism. This may be accomplished, for example, using the onboard computing device of HMD 172 and software, for example. The software may be configured to utilize algorithms and/or logic that allows the software to re-compute and/or distort the lightfield obtained by the HMD 172.

At block 560, method 550, includes render, based on the distorted lightfield data, a second lightfield comprising a second synthetic image that is related to the second feature of interest. Using the rendering techniques described above in regard to method 500, the second lightfield and second feature of interest may be rendered in a manner that compensates for the astigmatism.

D. Computing Device and Media

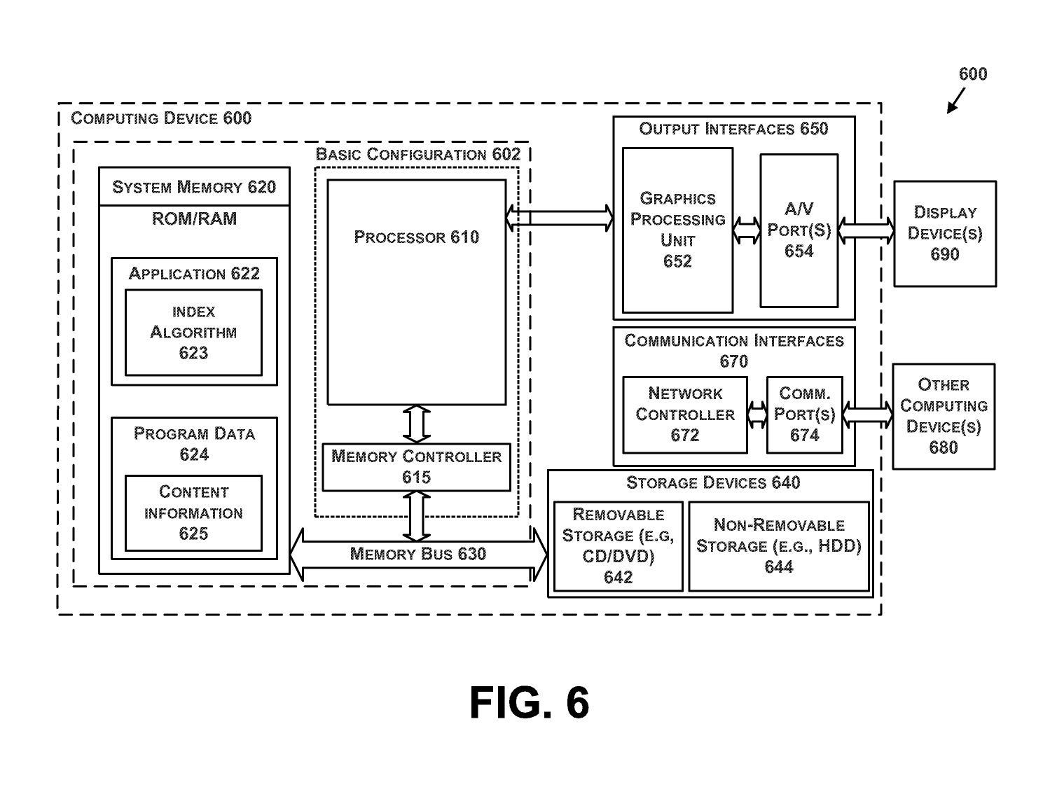

FIG. 6 illustrates a functional block diagram of an example of a computing device 600. The computing device 600 can be used to perform any of the functions discussed in this disclosure, including those functions discussed above in connection with FIGS. 3A and 3B, 4 and 5A-5B. In an implementation, the computing device 600 can be implemented as a portion of a head-mountable device, such as, for example, any of the HMDs discussed above in connection with FIGS. 1A-1D. In another implementation, the computing device 600 can be implemented as a portion of a small-form factor portable (or mobile) electronic device that is capable of communicating with an HMD; examples of such devices include a cell phone, a personal data assistant (PDA), a personal media player device, a wireless web-watch device, an application specific device, or a hybrid device that include any of the above functions. In another implementation, the computing device 610 can be implemented as a portion of a computer, such as, for example, a personal computer, a server, or a laptop, among others.

In a basic configuration 602, the computing device 600 can include one or more processors 610 and system memory 620. A memory bus 630 can be used for communicating between the processor 610 and the system memory 620. Depending on the desired configuration, the processor 610 can be of any type, including a microprocessor (μP), a microcontroller (μC), or a digital signal processor (DSP), among others. A memory controller 615 can also be used with the processor 610, or in some implementations, the memory controller 615 can be an internal part of the processor 610.

Depending on the desired configuration, the system memory 620 can be of any type, including volatile memory (such as RAM) and non-volatile memory (such as ROM, flash memory). The system memory 620 can include one or more applications 622 and program data 624. The application(s) 622 can include an index algorithm 623 that is arranged to provide inputs to the electronic circuits. The program data 624 can include content information 625 that can be directed to any number of types of data. The application 622 can be arranged to operate with the program data 624 on an operating system.

The computing device 600 can have additional features or functionality, and additional interfaces to facilitate communication between the basic configuration 602 and any devices and interfaces. For example, data storage devices 640 can be provided including removable storage devices 642, non-removable storage devices 644, or both. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives. Computer storage media can include volatile and nonvolatile, non-transitory, removable and non-removable media implemented in any method or technology for storage of information, such as computer readable instructions, data structures, program modules, or other data.

The system memory 620 and the storage devices 640 are examples of computer storage media. Computer storage media includes, but is not limited to, RAM, ROM, EEPROM, flash memory or other memory technology, CD-ROM, DVDs or other optical storage, magnetic cassettes, magnetic tape, magnetic disk storage or other magnetic storage devices, or any other medium that can be used to store the desired information and that can be accessed by the computing device 600.

The computing device 600 can also include output interfaces 650 that can include a graphics processing unit 652, which can be configured to communicate with various external devices, such as display devices 690 or speakers by way of one or more A/V ports or a communication interface 670. The communication interface 670 can include a network controller 672, which can be arranged to facilitate communication with one or more other computing devices 680 over a network communication by way of one or more communication ports 674. The communication connection is one example of a communication media. Communication media can be embodied by computer-readable instructions, data structures, program modules, or other data in a modulated data signal, such as a carrier wave or other transport mechanism, and includes any information delivery media. A modulated data signal can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR), and other wireless media.

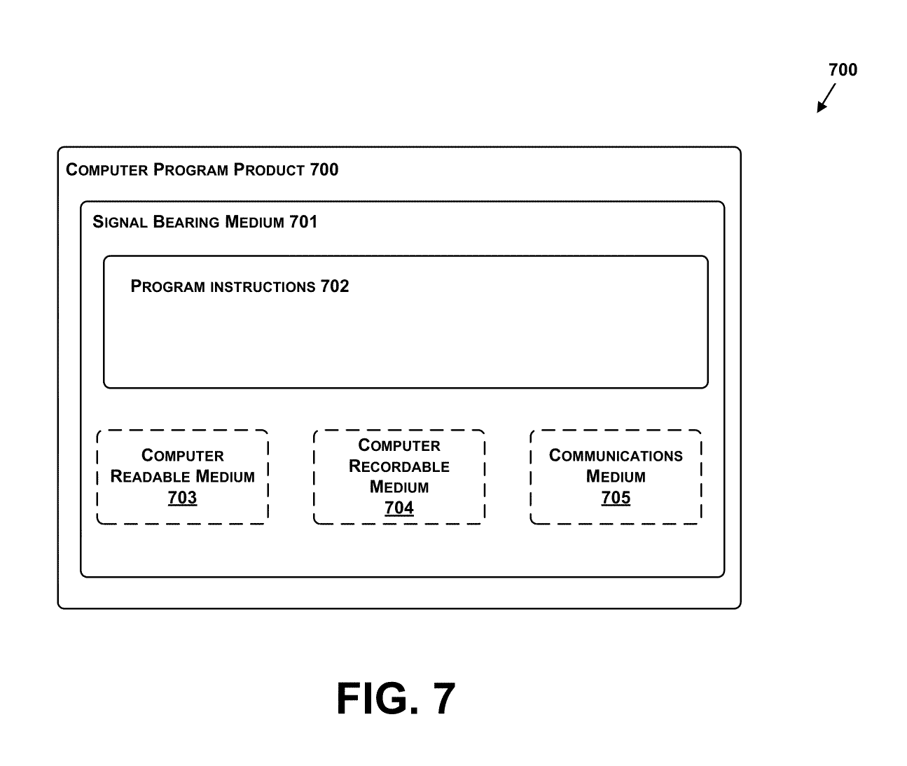

In some embodiments, the disclosed methods may be implemented as computer program instructions encoded on a non-transitory computer-readable storage media in a machine-readable format, or on other non-transitory media or articles of manufacture. FIG. 7 is a schematic illustrating a conceptual partial view of an example computer program product that includes a computer program for executing a computer process on a computing device, arranged according to at least some embodiments presented herein.

In one embodiment, the example computer program product 700 is provided using a signal bearing medium 701. The signal bearing medium 701 may include one or more programming instructions 702 that, when executed by one or more processors may provide functionality or portions of the functionality described above with respect to FIGS. 1-5. In some examples, the signal bearing medium 701 may encompass a computer-readable medium 703, such as, but not limited to, a hard disk drive, a Compact Disc (CD), a Digital Video Disk (DVD), a digital tape, memory, etc. In some implementations, the signal bearing medium 701 may encompass a computer recordable medium 704, such as, but not limited to, memory, read/write (R/W) CDs, R/W DVDs, etc. In some implementations, the signal bearing medium 701 may encompass a communications medium 705, such as, but not limited to, a digital and/or an analog communication medium (e.g., a fiber optic cable, a waveguide, a wired communications link, a wireless communication link, etc.). Thus, for example, the signal bearing medium 701 may be conveyed by a wireless form of the communications medium 705 (e.g., a wireless communications medium conforming with the IEEE 802.11 standard or other transmission protocol).

The one or more programming instructions 702 may be, for example, computer executable and/or logic implemented instructions. In some examples, a computing device such as the computing device 100 of FIG. 1 may be configured to provide various operations, functions, or actions in response to the programming instructions 702 conveyed to the computing device 700 by one or more of the computer readable medium 703, the computer recordable medium 704, and/or the communications medium 705.

It should be understood that arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

1. A head-mountable device (HMD) comprising:
a light-producing display engine;
a viewing element;
a microlens array coupled to the light-producing display engine in a manner such that light emitted from one or more pixels of the light-producing display engine is configured to follow an optical path through the microlens array to the viewing element;
at least one processor coupled to the light-producing display engine; and
a storage medium that provides instructions that, when executed by the at least one processor, will cause the HMD to perform operations including:
identifying a first feature of interest in a field-of-view associated with the HMD in an environment, wherein the first feature of interest is associated with a first location and perceived depth to the HMD in the environment, and wherein the first feature of interest is visible at the viewing element;
obtaining lightfield data indicative of the environment and the first feature of interest;
rendering, based on the lightfield data, a first lightfield comprising a first synthetic image that is related to the first feature of interest at a first focal point that corresponds to the first location and perceived depth for display at the viewing element;
identifying a second feature of interest in the field-of-view associated with the HMD in the environment, wherein the second feature of interest is associated with a second location and a second perceived depth to the HMD in the environment, and wherein the second feature of interest is visible at the viewing element;
obtaining lightfield data indicative of the environment and the second feature of interest; and
rendering, based on the lightfield data, simultaneous to the first lightfield, a second lightfield comprising a second synthetic image that is related to the second feature of interest at a second focal point that corresponds to the second location and perceived depth for display at the viewing element,
wherein rendering the first and second lightfields further comprises emitting light from the light-producing display engine along the optical path passing through the microlens array to the viewing element.

2. The head-mountable device of claim 1, wherein the microlens array includes a one-dimensional (1D) microlens array.

3. The head-mountable device of claim 1, wherein the microlens array includes a two-dimensional (2D) microlens array.

4. The head-mountable device of claim 1,
wherein the light-producing display engine comprises a plurality of pixels, and
wherein the microlens array includes one or more microlenses that correspond to the plurality of pixels and are disposed in front of the plurality of pixels and at a separation from the plurality of pixels.

5. The head-mountable device of claim 1, wherein the light-producing display engine comprises an Organic Light-Emitting Diode (OLED) display.

6. The head-mountable device of claim 1, wherein the light-producing display engine comprises a Light-Emitting Diode (LED) and a Liquid Crystal over Silicon (LCoS) display.

7. The head-mountable device of claim 1, wherein the light-producing display engine comprises a Digital Light Processing (DLP) projector.

8. The head-mountable device of claim 1, wherein the storage medium provides further instructions that, when executed by the processor, will cause the HMD to perform further operations, comprising:
receiving astigmatism information that defines an astigmatism associated with the HMD;
generating, based on the second lightfield data and the astigmatism information, distorted lightfield data that compensates for the astigmatism; and
rendering, based on the distorted lightfield data, simultaneous to the first lightfield, the second lightfield comprising the second synthetic image that is related to the second feature of interest at the second focal point that corresponds to the second depth for display at the viewing element.

9. The head-mountable device of claim 8, wherein the astigmatism is associated with a user of the device.

10. The head-mountable device of claim 8,
wherein the viewing element comprises a viewing lens, and
wherein the astigmatism is associated with the viewing lens.

11. A method comprising:
identifying, using at least one processor of a head-mountable device (HMD), a first feature of interest in a field-of-view view associated with the HMD in an environment, wherein:
the HMD comprises a light-producing display engine, a viewing element, and a microlens array coupled to the light-producing display engine in a manner such that light emitted from the light-producing display engine follows an optical path through the microlens array to the viewing element; and
the first feature of interest is associated with a first location and perceived depth to the HMD in the environment and visible at the viewing element;
obtaining lightfield data indicative of the environment and the first feature of interest;
rendering, based on the lightfield data, a first lightfield comprising a first synthetic image that is related to the first feature of interest at a first focal point that corresponds to the first location and perceived depth for display at the viewing element;
identifying, using at least one processor of the head-mountable device (HMD), a second feature of interest in a field-of-view view associated with the HMD in the environment, wherein:
the second feature of interest is associated with a second location and perceived depth to the HMD in the environment and visible at the viewing element;
obtaining second lightfield data indicative of the environment and the second feature of interest; and
rendering, based on the second lightfield data, simultaneous to the first lightfield, a second lightfield comprising a second synthetic image that is related to the second feature of interest at a second focal point that corresponds to the second location and perceived depth for display at the viewing element,
wherein rendering the first and second lightfields further comprises emitting light from the light-producing display engine along the optical path passing through the microlens array to the viewing element.

12. The method of claim 11, wherein the microlens array includes a one-dimensional (1D) microlens array.

13. The method of claim 11, wherein the microlens array includes a two-dimensional (2D) microlens array.

14. The method of claim 11,
wherein the light-producing display engine comprises a plurality of pixels, and
wherein the microlens array includes one or more microlenses that correspond to the plurality of pixels and are disposed in front of the plurality of pixels and at a separation from the plurality of pixels.

15. The method of claim 11, wherein the light-producing display engine comprises an Organic Light-Emitting Diode (OLED) display.

16. The method of claim 11, wherein the light-producing display engine comprises a Light-Emitting Diode (LED) and a Liquid Crystal over Silicon (LCoS) display.

17. The method of claim 11, wherein the light-producing display engine comprises a Digital Light Processing (DLP) projector

18. The method of claim 11, further comprising:
receiving astigmatism information that defines an astigmatism associated with the HMD;
generating, based on the second lightfield data and the astigmatism information, distorted lightfield data that compensates for the astigmatism; and
rendering, based on the distorted lightfield data, simultaneous to the first lightfield, the second lightfield comprising the second synthetic image that is related to the second feature of interest at the second focal point that corresponds to the second depth for display at the viewing element.

19. The method of claim 18, wherein the astigmatism is associated with a user of the device.

20. The method of claim 18,
wherein the viewing element comprises a viewing lens, and
wherein the astigmatism is associated with the viewing lens.
